(19) United States
(12) Patent Application Publication
(10) Pub. No.: US 2025/0286941 A1
(43) Pub. Date: Sep. 11, 2025

(54) MOBILE PHONE CASE WITH REAR CAMERA PROTECTION

(71) Applicant: Pengtao Zhang, Shenzhen (CN)

(72) Inventor: Pengtao Zhang, Shenzhen (CN)

(21) Appl. No.: 18/757,947

(22) Filed: Jun. 28, 2024

(30) Foreign Application Priority Data
Mar. 11, 2024 (CN) 202420474851.9

(51) Int. Cl. H04M 1/02

(52) U.S. Cl. CPC H04M 1/0264; H04M 1/0237

(57) ABSTRACT

The present disclosure provides a mobile phone case with rear camera protection, comprising: a case is provided with a window corresponding to the rear camera; a bracket is arranged on the back of the case; the bracket is provided with an opening matching the size of the window and corresponding to the window, a sliding rail is arranged adjacent to the opening; the sliding cover is adapted to the size of the opening and is slidably disposed on the sliding rail, the sliding cover is provided with a first magnetic member and a second magnetic member at both ends along the sliding direction of the sliding rail, one end of the sliding rail close to the opening is provided with a third magnetic member; when the sliding cover slides to the end of the sliding rail, the first magnetic member or the second magnetic member corresponds to the third magnetic member.

### TECHNICAL FIELD

The present disclosure relates to a technical field of mobile phone accessories, and in particular to a mobile phone case with rear camera protection.

### BACKGROUND

A mobile phone case is a device used to protect the appearance of a mobile phone and extend its service life. They are usually made of materials such as plastic, silicone, leather or metal and fixed to the outer shell of the mobile phone. The mobile phone case can prevent the mobile phone from falling, breaking or scratching, and can also protect the mobile phone from dust, dirt and other contamination. In addition, some mobile phone cases also have anti-slip, waterproof, anti-fingerprint and other functions.

Existing mobile phone cases can not only protect mobile phones, but also beautify the appearance of mobile phones. However, many existing mobile phone cases cannot effectively protect mobile phones' camera when in use. Subsequently, many mobile phone cases can wrap mobile phone cameras, but cannot fully cover the mobile phone, so there is still a risk when the mobile phone falls, causing damage to the mobile phone camera. In addition, existing mobile phone cases have relatively few functions. Therefore, it is urgent to solve the above problems.

### SUMMARY

The present disclosure provides a mobile phone case with rear camera protection, in order to solve the problems that the mobile phone camera is easily scratched and not drop-resistant when the existing mobile phone case is used.

The working process of the mobile phone case with rear camera protection of the present application is as follows: the mobile phone case with rear camera protection, comprising: a case, a bracket and a sliding cover, wherein: the case is provided with a window corresponding to the rear camera of the mobile phone; the bracket is arranged on the back of the case; the bracket is provided with an opening matching the size of the window and facing the window, and a sliding rail is arranged adjacent to the opening; the sliding cover is adapted to the size of the opening and is slidably disposed on the sliding rail, the sliding cover is provided with a first magnetic member and a second magnetic member at both ends along the sliding direction of the sliding rail, one end of the sliding rail close to the opening is provided with a third magnetic member; when the sliding cover slides to the end of the sliding rail, the first magnetic member or the second magnetic member corresponds to the third magnetic member.

Furthermore, one end of the bracket is rotatably connected to the case, and when the bracket is rotated to fit on the case, the opening is corresponding to the window.

Furthermore, one side edge of the case is provided with a perforation, the inner side of the case adjacent to the perforation is provided with a first mounting portion, the side where the bracket fits the case is provided with a second mounting portion, the perforation is provided with a hinge, the hinge comprises a first hinge piece and a second hinge piece, one side of the first hinge piece is hinged to one side of the second hinge piece, the first hinge piece is fixedly connected to the first mounting portion, the second hinge piece is fixedly connected to the second mounting portion.

Furthermore, the first hinge piece and the second hinge piece are both provided with a plurality of fixing holes, the first mounting portion and the second mounting portion are both provided with a plurality of fixing columns, the fixing columns are sleeved in the fixing holes.

Furthermore, the surfaces of the first hinge piece and the second hinge piece are both provided with spacer sheets.

Furthermore, the edge of the bracket is provided with a limiting sidewall, the limiting sidewall is provided with a limiting groove, the side of the sliding cover is provided with a limiting protrusion, and the limiting protrusion is slidably arranged in the limiting groove.

Furthermore, the other end of the bracket is provided with a bayonet.

Furthermore, the sliding cover is also provided with a protruding portion.

Furthermore, the side where the bracket fits the case is provided with an auxiliary bracket groove, the auxiliary bracket groove is provided with an auxiliary bracket, one end of the auxiliary bracket is rotatably connected to the inner wall of the auxiliary bracket groove, the other end of the auxiliary bracket is provided with a limiting port, and the case is provided with a bayonet hole, a hole wall at the entrance of the bayonet hole is provided with a clamping portion matching the limiting port, when the auxiliary bracket is opened, one end of the auxiliary bracket provided with the limiting port is inserted into the bayonet hole, and the limiting port is engaged with the clamping portion.

The present disclosure has beneficial effects as follows.

The present disclosure provides a mobile phone case with rear camera protection, which is provided with a sliding rail on the back of the case near the window. A sliding cover is slidably arranged on the sliding rail. When the rear camera of the mobile phone is not needed, the sliding cover can be slid to a position where the window is completely covered, thereby sealing the rear camera of the mobile phone to protect the rear camera. When the rear camera of the mobile phone needs to be used, the sliding cover can be slid to a position offset from the window so that the user can use the camera function of the rear camera normally. Furthermore, by arranging the first magnetic member and the second magnetic member at both ends of the sliding cover along the sliding direction, and arranging the third magnetic member near the window on the sliding rail. When the sliding cover is slid to completely cover the window, the first magnetic member corresponds to the third magnetic member, and a gravitational force of attraction is generated between the two. When the sliding cover is slid to be completely offset from the window, the second magnetic member corresponds to the third magnetic member, and a gravitational force of attraction is generated between the two, so that the sliding cover will not be slid when no external force is applied, thereby avoiding affecting the user's normal use of the camera function of the rear camera of the mobile phone.

### BRIEF DESCRIPTION OF DRAWINGS

In order to more clearly illustrate technical solutions in embodiments of the present disclosure, drawings required in description or prior art are briefly introduced below, and obviously, the drawings in the following description are merely some embodiments of the present disclosure. For a person having ordinary skill in art, other drawings may be obtained according to the drawings without creative efforts.

FIG. 1 is a schematic structural diagram of an embodiment of a mobile phone case with rear camera protection;

FIG. 2 is a schematic structural diagram of another embodiment of the mobile phone case with rear camera protection;

FIG. 3 is a schematic diagram of the exploded structure of an embodiment of the mobile phone case with rear camera protection;

FIG. 4 is a schematic structural diagram of a bracket of an embodiment of the mobile phone case with rear camera protection;

FIG. 5 is a schematic structural diagram of a sliding cover of an embodiment of the mobile phone case with rear camera protection;

FIG. 6 is another structural schematic diagram of an embodiment of the mobile phone case with rear camera protection;

FIG. 7 is a schematic structural diagram of a case of an embodiment of the mobile phone case with rear camera protection;

FIG. 8 is a schematic structural diagram of a hinge of an embodiment of the mobile phone case with rear camera protection;

FIG. 9 is another schematic diagram of the structure of a bracket of an embodiment of the mobile phone case with rear camera protection;

FIG. 10 is another structural schematic diagram of an embodiment of the mobile phone case with rear camera protection;

FIG. 11 is a structural schematic diagram of an auxiliary bracket of an embodiment of the mobile phone case with rear camera protection.

Reference number in the drawings:

| | | | |
|---|---|---|---|
| case | 1 | bracket | 2 |
| sliding cover | 3 | hinge | 4 |
| window | 11 | perforation | 12 |
| first mounting portion | 13 | spacer sheet | 14 |
| fixing column | 15 | bayonet hole | 16 |
| opening | 21 | sliding rail | 22 |
| third magnetic member | 23 | second mounting portion | 24 |
| limiting sidewall | 25 | limiting groove | 26 |
| bayonet | 27 | auxiliary bracket groove | 28 |
| limiting port | 291 | auxiliary bracket | 29 |
| first magnetic member | 31 | second magnetic member | 32 |
| first hinge piece | 41 | second hinge piece | 42 |
| fixing hole | 43 | clamping portion | 161 |
| limiting protrusion | 33 | protruding portion | 34 |

### DETAILED DESCRIPTION

The following describes in detail the embodiments of the present disclosure, examples of which are illustrated in the accompanying drawings, wherein the same or similar reference numerals refer to the same or similar elements or elements having the same or similar functions throughout. The embodiments described below with reference to the accompanying drawings are exemplary, and are not intended to limit the present disclosure.

In order to make the purpose, technical solutions, and advantages of the present disclosure clear, the following further describes the present disclosure in detail with reference to accompanying drawings and embodiments.

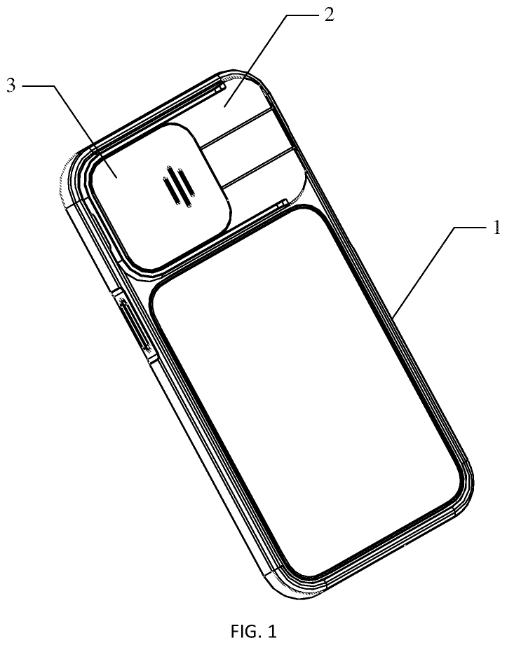

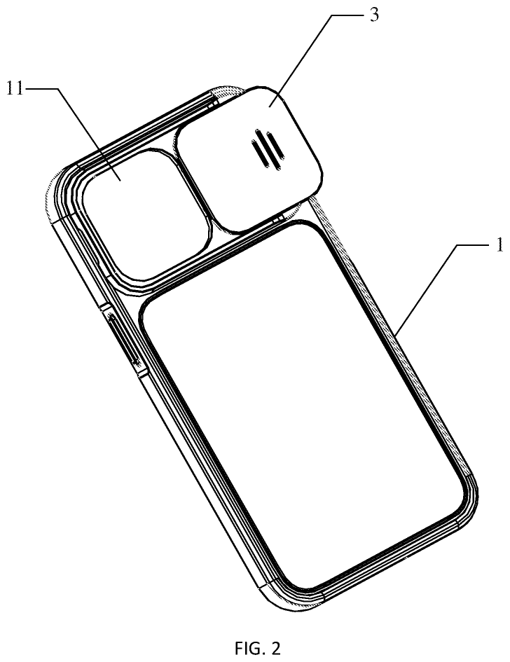

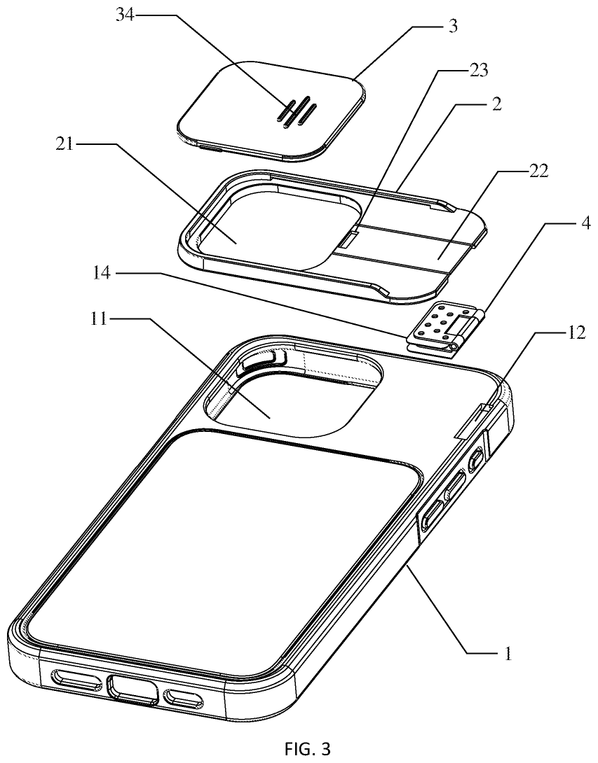

FIG. 1, FIG. 2 and FIG. 3 show the structural schematic diagrams of an embodiment of a mobile phone case with rear camera protection of the present invention. Referring to FIG. 1, FIG. 2 and FIG. 3, the embodiment of the present disclosure provides a mobile phone case with rear camera protection, comprising: a case 1, a bracket 2 and a sliding cover 3.

Wherein the case 1 is provided with a window 11 corresponding to the rear camera of the mobile phone. It should be noted that the positions of the rear cameras of mobile phones of different brands and models are different. Therefore, the position of the window 11 set on the case 1 needs to be set at a corresponding position according to the brand and model of the mobile phone.

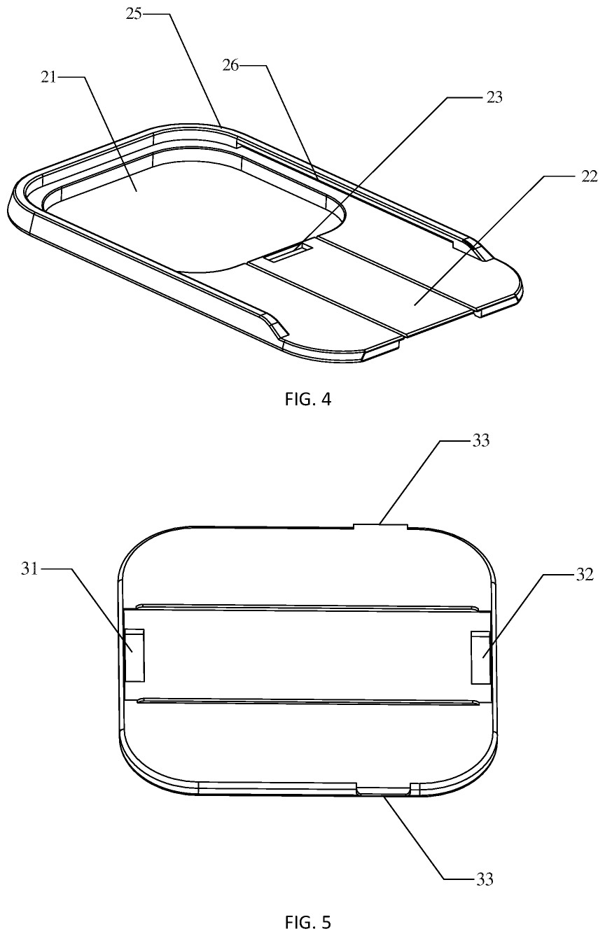

Referring to FIG. 4, the bracket 2 is arranged on the back of the case 1, the bracket 2 is provided with an opening 21 matching the size of the window 11 and facing the window 11, and a sliding rail 22 is arranged adjacent to the opening 21, wherein the opening 21 and the sliding rail 22 are arranged side by side.

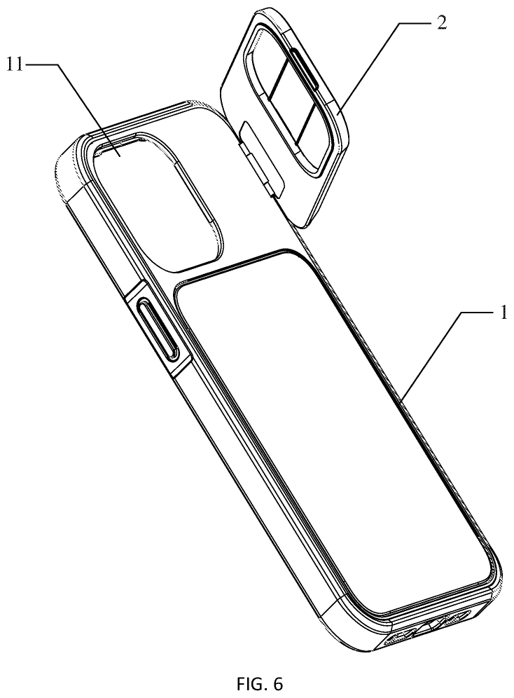

Referring to FIG. 5, the sliding cover 3 is adapted to the size of the opening 21 and is slidably set on the sliding rail 22, the sliding cover 3 is provided with a first magnetic member 31 and a second magnetic member 32 at both ends along the sliding direction of the sliding rail 22, one end of the sliding rail 22 close to the opening 21 is provided with a third magnetic member 23; when the sliding cover 3 slides to the end of the sliding rail 22, the first magnetic member 31 or the second magnetic member 32 corresponds to the third magnetic member 23. Specifically, as shown in FIG. 1, when the sliding cover 3 is slid to completely cover the window 11, the first magnetic member 31 is corresponding to the third magnetic member 23, and a gravitational force of attraction force is generated between the two, thereby achieving the purpose of fixing the sliding cover 3, so that the sliding cover 3 will not slide without human intervention, thereby achieving the purpose of protecting the rear camera of the mobile phone. As shown in FIG. 2, when the sliding cover 3 slides to be completely offset from the window 11, the second magnetic member 32 is corresponding to the third magnetic member 23, and the two also generate a mutual attractive force, thereby achieving the purpose of fixing the sliding cover 3, so that the sliding cover 3 will not slide without human intervention, avoiding the sliding cover 3 from sliding to a position that blocks the rear camera when the user uses the rear camera to take photos, thereby affecting the user's normal use.

In this embodiment, the mobile phone case with rear camera protection of this embodiment is provided with the sliding rail 22 on the back of the case 1 near the window 11, and the sliding cover 3 is slidably provided on the sliding rail 22. When the rear camera of the mobile phone is not needed, the sliding cover 3 is slid to a position where the window 11 is completely covered, thereby closing the rear camera of the mobile phone and protecting the rear camera. When the rear camera of the mobile phone needs to be used, the sliding cover 3 is slid to a position offset from the window 11 so that the user can use the camera function of the rear camera normally. Furthermore, by arranging the first magnetic member 31 and the second magnetic member 32 at both ends of the sliding cover 3 along the sliding direction, and arranging the third magnetic member 23 at the slide rail 22 near the window 11, when the sliding cover 3 is slid to completely cover the window 11, the first magnetic member 31 corresponds to the third magnetic member 23, and a gravitational force of attraction is generated between the two. When the sliding cover 3 is slid to be completely offset from the window 11, the second magnetic member 32 corresponds to the third magnetic member 23, and a gravitational force of attraction is generated between the two, so that the sliding cover 3 will not slid when no external force is applied, thereby avoiding affecting the user's normal use of the camera function of the rear camera of the mobile phone.

Furthermore, in order to enrich the functions of the mobile phone case and thus improve the user's experience, based on the above embodiments, in other embodiments, one end of the bracket 2 is rotatably connected to the shell 1, and when the bracket 2 is rotated to fit on the case1, the opening 21 corresponds to the window 11.

Specifically, referring to FIG. 6, one end of the bracket 2 is rotatably connected to the case 1, so that the bracket 2 can rotate around the rotatable connection as the axis, so that a certain angle is formed between the bracket 2 and the case 1. After the bracket 2 is rotated to a certain angle, the mobile phone is placed horizontally, the bracket 2 plays a supporting role, so that the mobile phone can be tilted and placed on a flat area such as a desktop, which is convenient for users to view. The user does not need to manually support the mobile phone, freeing the user's hands and providing a better user experience.

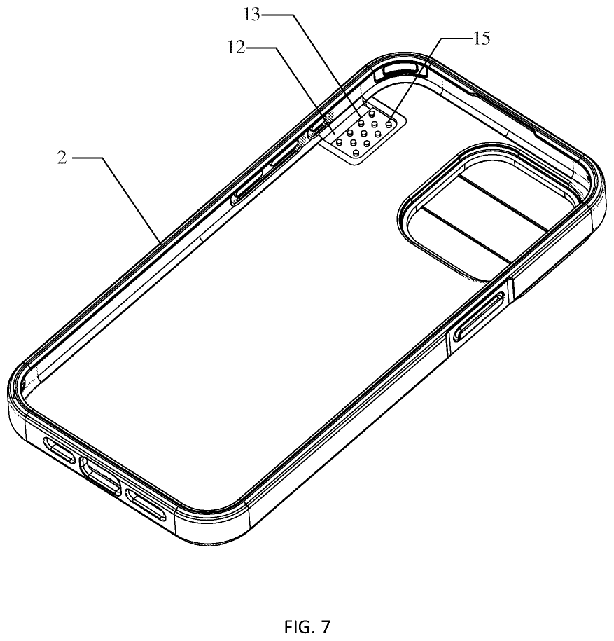

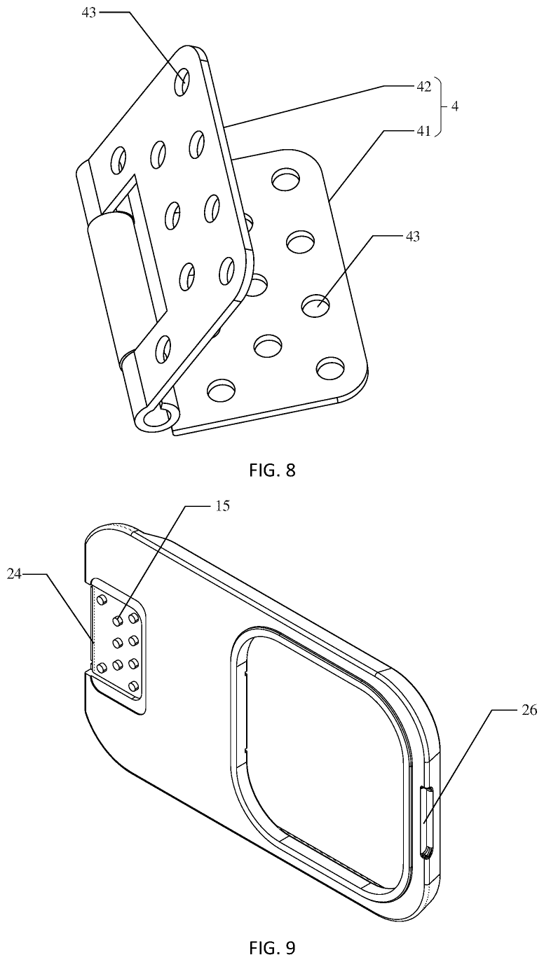

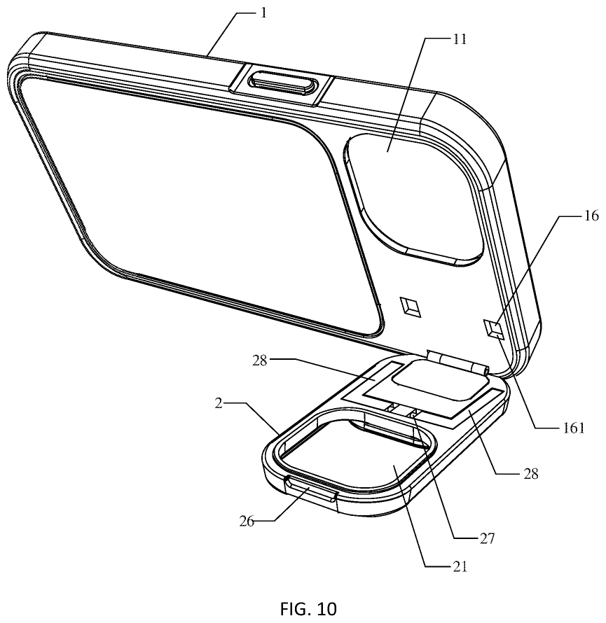

Referring to FIG. 2, FIG. 7, FIG. 8 and FIG. 9, one side edge of the case 1 is provided with a perforation 12, the inner side of the case 1 adjacent to the perforation 12 is provided with a first mounting portion 13, the side where the bracket 2 fits the case 1 is provided with a second mounting portion 24, the perforation 12 is provided with a hinge 4, the hinge 4 comprises a first hinge piece 41 and a second hinge piece 42, one side of the first hinge piece 41 is hinged to one side of the second hinge piece 42, the first hinge piece 41 is fixedly connected to the first mounting portion 13, the second hinge piece 42 is fixedly connected to the second mounting portion 24.

Specifically, in this embodiment, the first mounting portion 13 is arranged on the inner side surface of the shell 1, and the perforation 12 is arranged on the case 1, so that the first hinge piece 41 of the hinge 4 can pass through the perforation 12 and be fixedly connected to the first mounting portion 13, and the second hinge piece 42 of the hinge 4 is fixedly connected to the second mounting portion 24 arranged on the bracket 2. On the one hand, this structure can make the hinge of the first hinge piece 41 and the second hinge piece 42 hidden in the perforation 12, so that it will not protrude too much relative to the outer surface of the case 1, thereby avoiding affecting the appearance of the mobile phone case; on the other hand, the first hinge piece 41 and the second hinge piece 42 are equivalent to being located on both sides of the case 1, so that the hinge between the bracket 2 and the case 1 is more stable and not easy to be damaged.

It should be noted that the first mounting portion 13 is recessed inwardly to a certain depth relative to the surface of the inner side surface of the case 1, so that when the first hinge piece 41 is fixedly connected to the first mounting portion 13, the surface of the first hinge piece 41 is just flush with the surface of the inner side surface of the case 1. The second mounting portion 24 is recessed inwardly to a certain depth relative to the surface of the bracket 2, so that when the second hinge piece 42 is fixedly connected to the second mounting portion 24, the surface of the second hinge piece 42 is just flush with the surface of the bracket 2.

Furthermore, in order to ensure the stability of the connection between the hinge 4 and the case 1, as well as between the hinge 4 and the bracket 2, the first hinge piece 41 and the second hinge piece 42 are both provided with a plurality of fixing holes 43, the first mounting portion 13 and the second mounting portion 24 are both provided with a plurality of fixing columns 15, the fixing columns 15 are sleeved in the fixing holes 43.

Specifically, the plurality of fixing holes 43 are provided on the first hinge piece 41 and the second hinge piece 42, and each fixing hole 43 is sleeved with a fixing column 15 at the first mounting portion 13 or the second mounting portion 24. Through the cooperation of the plurality of fixing holes 43 and the plurality of fixing columns 15, the connection between the first hinge piece 41 and the first mounting portion 13 is more secure, and the connection between the second hinge piece 42 and the second mounting portion 24 is more secure.

Furthermore, in order to prevent the hinge 4 from causing wear to the case 1 and the mobile phone when the hinge 4 rotates frequently, in some embodiment, the surfaces of the first hinge piece 41 and the second hinge piece 42 are both provided with spacer sheets 14.

Specifically, by providing the spacer sheets 14, the first hinge piece 41 will not directly contact the back of the mobile phone, and the second hinge piece 42 will not directly contact the outer surface of the case 1, thereby preventing the first hinge piece 41 and the second hinge piece 42 from causing wear to the mobile phone and the case 1.

Furthermore, in order to make the sliding cover 3 slide better on the bracket 2, in some embodiments, please refer to FIG. 4 and FIG. 5, the edge of the bracket 2 is provided with a limiting sidewall 25, the limiting sidewall 25 is provided with a limiting groove 26, the side of the sliding cover 3 is provided with a limiting protrusion 33, and the limiting protrusion 33 is slidably arranged in the limiting groove 26.

Specifically, the limiting sidewall 25 is disposed at the edge of the bracket 3 in a semi-enclosed form, and the limiting sidewall 25 is not disposed at the edge adjacent to the end of the sliding rail 22. By setting the limiting groove 26 on the inner side of the limiting sidewall 25 parallel to the sliding direction of the sliding cover 3, setting limiting protrusions 33 on the two side edges of the sliding cover 3 parallel to the sliding direction, and the limiting protrusion 33 is slid into the limiting groove 26, the sliding of the sliding cover 3 is restricted by the limiting groove 26, so that the sliding cover 3 will not fall off when sliding on the sliding rail 22.

Furthermore, in order to facilitate opening of the bracket 2, in some embodiments, as shown in FIG. 9, the other end of the bracket 2 is provided with a bayonet 27.

Specifically, by providing the bayonet 27, the user can conveniently hold the bayonet 27 with a fingernail and then rotate the bracket 2, making the operation more convenient for the user.

Furthermore, in order to facilitate the user to move the sliding cover 3, please refer to FIG. 3, the sliding cover 3 is also provided with a protruding portion 34.

Specifically, by providing the protruding portion 34, the user can press the protruding portion 34 with a certain force, and use the protruding portion 34 to increase the friction between the finger and the sliding cover 3, and then slide the sliding cover 3, so that the sliding cover 3 is easier to be slid.

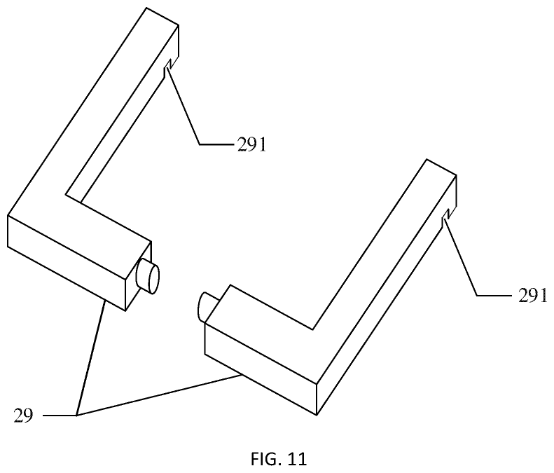

Furthermore, as shown in FIG. 10, the side where the bracket 2 fits the case 1 is provided with an auxiliary bracket groove 28, the auxiliary bracket groove 28 is provided with an auxiliary bracket 29, one end of the auxiliary bracket 29 is rotatably connected to the inner wall of the auxiliary bracket groove 28, the other end of the auxiliary bracket 29 is provided with a limiting port 291 (referring to FIG. 11), and the case 1 is provided with a bayonet hole 16, a hole wall at the entrance of the bayonet hole 16 is provided with a clamping portion 161 matching the limiting port 291, when the auxiliary bracket 29 is opened, one end of the auxiliary bracket 29 provided with the limiting port 291 is inserted into the bayonet hole 16, and the limiting port 291 is engaged with the clamping portion 161.

Specifically, when the bracket 2 is opened and used as a mobile phone bracket, the auxiliary bracket 29 is rotated open from the auxiliary bracket groove 28, and then the movable end of the auxiliary bracket 29 is inserted into the bayonet hole 16, and the limiting port 291 is engaged with the the clamping portion 161 to ensure that the auxiliary bracket 29 is stably engaged in the bayonet hole 16.

In this embodiment, the auxiliary bracket 29 is provided to make the bracket 2 more stable when it is opened as a support frame to support the mobile phone, thereby preventing the bracket 2 from rotating during use and ensuring the stability of the bracket function.

Furthermore, based on the above embodiment, in other embodiments, a card placement compartment is further provided in the sliding cover 3, and the size of the card placement compartment is matched with the size of the ID card and the bank card, so that the user can place cards such as the ID card and the bank card. When a card needs to be placed, the sliding cover 3 is slid to one side to open the card placement compartment. After the card is placed, the sliding cover 3 is slid again to close the card placement compartment. The purpose of fixing the sliding cover 3 is achieved by matching the sliding cover 3 with the magnetic parts on the sliding rail. In this embodiment, a card placement compartment is provided on the mobile phone case, so that the user can well keep the cards that need to be carried with him/her without carrying a wallet, thereby improving the user's experience.

Above are only preferred embodiments of the present disclosure and are not intended to limit the present disclosure. Any modification, equivalent replacement and improvement made within spirit and principle of the present disclosure should be included in protection scope of the present disclosure.

1. A mobile phone case with rear camera protection, comprising: a case, a bracket and a sliding cover, wherein:
the case is provided with a window corresponding to the rear camera of the mobile phone;
the bracket is arranged on the back of the case;
the bracket is provided with an opening matching the size of the window and facing the window, and a sliding rail is arranged adjacent to the opening;
the sliding cover is adapted to the size of the opening and is slidably disposed on the sliding rail, the sliding cover is provided with a first magnetic member and a second magnetic member at both ends along the sliding direction of the sliding rail, the sliding rail is provided with one sliding-rail magnetic member, the one sliding-rail magnetic member is located at one end of the sliding rail close to the opening; when the sliding cover slides to the end of the sliding rail, the first magnetic member or the second magnetic member corresponds to the one sliding-rail magnetic member;
when the first magnetic member corresponds to the one sliding-rail magnetic member, the first magnetic member coincides with the one sliding-rail magnetic member in a direction perpendicular to a plane in which the sliding direction of the sliding rail is located; and
when the second magnetic member corresponds to the one sliding-rail magnetic member, the second magnetic member coincides with the one sliding-rail magnetic member in the direction perpendicular to the plane in which the sliding direction of the sliding rail is located.

2. The mobile phone case with rear camera protection of claim 1, wherein one end of the bracket is rotatably connected to the case, and when the bracket is rotated to fit on the case, the opening is corresponding to the window.

3. The mobile phone case with rear camera protection of claim 2, wherein one side edge of the case is provided with a perforation, the inner side of the case adjacent to the perforation is provided with a first mounting portion, the bracket fitted to one side of the case is provided with a second mounting portion, the perforation is provided with a hinge, the hinge comprises a first hinge piece and a second hinge piece, one side of the first hinge piece is hinged to one side of the second hinge piece, the first hinge piece is fixedly connected to the first mounting portion, the second hinge piece is fixedly connected to the second mounting portion.

4. The mobile phone case with rear camera protection of claim 3, wherein the first hinge piece and the second hinge piece are both provided with a plurality of fixing holes, the first mounting portion and the second mounting portion are both provided with a plurality of fixing columns, the fixing columns are sleeved in the fixing holes.

5. The mobile phone case with rear camera protection of claim 3, wherein the surfaces of the first hinge piece and the second hinge piece are both provided with spacer sheets.

6. The mobile phone case with rear camera protection of claim 1, wherein the edge of the bracket is provided with a limiting sidewall, the limiting sidewall is provided with a limiting groove, the side of the sliding cover is provided with a limiting protrusion, and the limiting protrusion is slidably arranged in the limiting groove.

7. The mobile phone case with rear camera protection of claim 1, wherein the other end of the bracket is provided with a bayonet.

8. The mobile phone case with rear camera protection of claim 1, wherein the sliding cover is also provided with a protruding portion.

9. The mobile phone case with rear camera protection of claim 1, wherein the side where the bracket fits the case is provided with an auxiliary bracket groove, the auxiliary bracket groove is provided with an auxiliary bracket, one end of the auxiliary bracket is rotatably connected to the inner wall of the auxiliary bracket groove, the other end of the auxiliary bracket is provided with the limiting port, and the case is provided with a bayonet hole, a hole wall at the entrance of the bayonet hole is provided with a clamping portion matching the limiting port; when the auxiliary bracket is opened, one end provided with the limiting port is inserted into the bayonet hole, and the limiting port is engaged with the clamping portion.
